(19) United States
(12) Patent Application Publication
(10) Pub. No.: US 2021/0004841 A1
(43) Pub. Date: Jan. 7, 2021

(54) USER ATTRIBUTE ESTIMATION SYSTEM BASED ON IP ADDRESS

(71) Applicant: Geolocation Technology, Inc., Mishima-shi, Shizuoka (JP)

(72) Inventor: Keisuke YAMAMOTO, Mishima-shi, Shizuoka (JP)

(21) Appl. No.: 16/330,231

(22) PCT Filed: Apr. 27, 2018
(86) PCT No.: PCT/JP2018/017225

§ 371 Date: Mar. 4, 2019

(51) Int. Cl. G06Q 30/02; G06Q 10/04; H04L 29/12; H04L 29/08

(52) U.S. Cl. CPC G06Q 30/02; H04L 67/306; H04L 61/1511; G06Q 10/04

(57) ABSTRACT

IP address attribute information in which an IP address is associated with attribute information specifiable based on the IP address is acquired from a first database 101 together with date and time information of the history. On the other hand, user identifier attribute information in which a user identifier acquired when a user terminal accesses a website is associated with an IP address and browsing related information acquired through the access to the website is acquired from a second database 201 together with date and time information of the history. Then, history information of the IP address attribute information acquired from the first database 101 and history information of the user identifier attribute information acquired from the second database 201 are integrated into a third database 301 by using the IP address and the date and time information of the history as a key, and then the attribute of the user is estimated based on the information stored in the third database 301.

### TECHNICAL FIELD

The present invention relates to a user attribute estimation system based on an IP address, and in particular, to a user attribute estimation system based on an IP address suitable for being used in a system for estimating an attribute of a user using an IP address.

### BACKGROUND ART

Conventionally, a targeting system has been widely used that estimates a living area such as the place of residence or the place of work of a user, personal attributes such as age and sex, objects of interest, and the like based on information regarding the access history or action history of the user on the network and distributes information, such as advertisements, according to the estimated content. For example, a system that estimates a location or a region where a user is present based on an IP address is known (for example, refer to Patent Documents 1 to 3).

Each information transmission system disclosed in Patent Documents 1 and 2 includes user address acquisition means for acquiring an IP address of a user, a regional address classification database in which a plurality of IP addresses are classified according to regions in advance, and a file classification database for designating a file to be transmitted according to regional classification among a plurality of files. The classification of the region is determined from the IP address of the user obtained by the user address acquisition means by referring to the regional address classification database, and a file corresponding to the classification is designated based on the file classification database and transmitted to the user's computer.

In the IP address acquisition classification system disclosed in Patent Document 3, an IP address of the access point of the Internet service provider is acquired, and a domain name corresponding to the IP address is acquired. Then, a network name is extracted from the character string forming the domain name to determine the provider name, and a host name is extracted from the character string forming the domain name. In addition, the regional classification is determined from the acquired host name by referring to a regional host name classification table in which host names are classified according to regions, and the determined region is stored so as to be associated with the IP address, thereby constructing a regional classification database of IP addresses. Then, access statistics, information transmission, and data rearrangement using the regional classification database are performed.

Further, a system that estimates information other than the location or the region of a user based on an IP address is also known (for example, refer to Patent Documents 4 and 5). In the user information acquisition apparatus disclosed in Patent Document 4, a WWW server transmits an IP address of a user terminal under access to a caller number acquisition unit. The caller number acquisition unit inquires of a network terminating apparatus about the received IP address to acquire a corresponding user ID. In addition, the caller number acquisition unit inquires of an RAS about the acquired user ID to acquire a corresponding caller number. A user information acquisition unit searches a user information database based on the acquired caller number, and acquires user information corresponding to the caller number.

In a group targeting system disclosed in Patent Document 5, the number of connections per unit time is calculated using browser cookie, and an IP address for which the number of connections per unit time is equal to or greater than a set number is extracted as a group IP address or an IP address band, in which remaining addresses excluding the digit of the fourth section in the IP address system configured to include four sections are the same, is extracted as a group IP address. Then, by referring to a database, in which the IP address band, group size, location, trader name, and industry type are mapped and stored, using the extracted group IP address, the characteristics of the group (size of the group, location of the group, trader name of the group, industry type of the group, and the like) using the group IP address are determined.

All of the systems disclosed in Patent Documents 1 to 5 are configured such that a database, in which an IP address is associated with information to be acquired corresponding thereto, is built in advance and information (location or region of the user, user information, size or location of the group, trader name, industry type, and the like) corresponding to the IP address is acquired by referring to the database based on the IP address acquired when the user terminal accesses the network.

Therefore, even though a certain IP address is acquired when the user terminal accesses the network, naturally, it is not possible to acquire information that is not stored in a classification database corresponding to the IP address. For example, in the case of using a classification database in which IP addresses and regions are stored so as to be associated with each other, it is not possible to acquire information other than the region corresponding to the IP address acquired at the time of access to the network.

### CITATION LIST

### Patent Document

Patent Document 1: JP-A-2001-188732
Patent Document 2: JP-A-2001-312661
Patent Document 3: JP-A-2002-198997
Patent Document 4: JP-A-2002-232592
Patent Document 5: JP-A-2013-73628

### SUMMARY OF THE INVENTION

The invention has been made to solve the aforementioned problems, and it is an object of the invention to increase the number of pieces of user attribute information that can be acquired corresponding to an IP address acquired at the time of access to a network.

In order to solve the problems described above, in the invention, IP address attribute information in which an IP address is associated with attribute information specifiable based on the IP address is acquired from a first database in which the IP address attribute information is stored as history information. On the other hand, user identifier attribute information in which a user identifier acquired when a user terminal accesses a website is associated with an IP address and browsing related information acquired through the access to the website is acquired from a second database in which the user identifier attribute information is stored as history information. Then, history information of the IP address attribute information acquired from the first database and history information of the user identifier attribute information acquired from the second database are integrated into a third database by using the IP address and the date and time information of the history as a key, and then the attribute of the user is estimated based on the information stored in the third database.

According to the invention configured as described above, although only the attribute information unique to the IP address can be obtained from the IP address in a case where only the first database is used, the attribute information unique to the IP address and the browsing related information of the website by the user are stored so as to be associated with the IP address and the user identifier since the user identifier and the browsing related information of the website are acquired from the second database together with the IP address and the information acquired from the respective databases is integrated into the third database by using the IP address and the date and time information of the history as a key. Then, based on the integrated information, the attribute of the user specified by the user identifier is estimated. Therefore, it is possible to estimate the attribute of the user that cannot be estimated with only the information of the first database or only the information of the second database. As a result, it is possible to increase the number of pieces of user attribute information that can be acquired corresponding to the IP address acquired at the time of access to the network.

### BRIEF DESCRIPTION OF THE DRAWINGS

FIG. 1 is a diagram illustrating the overall configuration of a user attribute estimation system based on an IP address according to the present embodiment together with a functional block of a user attribute estimation apparatus.

FIG. 2 is a diagram showing an example of the record of history information stored in a first database.

FIG. 3 is a diagram showing an example of the record of history information stored in a second database.

FIG. 4 is a diagram showing an example of integrated information stored in a third database.

FIG. 5 is a diagram showing an example of user attributes estimated by an attribute estimation unit of the present embodiment.

FIG. 6 is a diagram showing an example of the user's action situation estimated by the attribute estimation unit of the present embodiment.

FIG. 7 is a diagram illustrating an example of the functional configuration of a user attribute estimation apparatus according to another embodiment.

### MODE FOR CARRYING OUT THE INVENTION

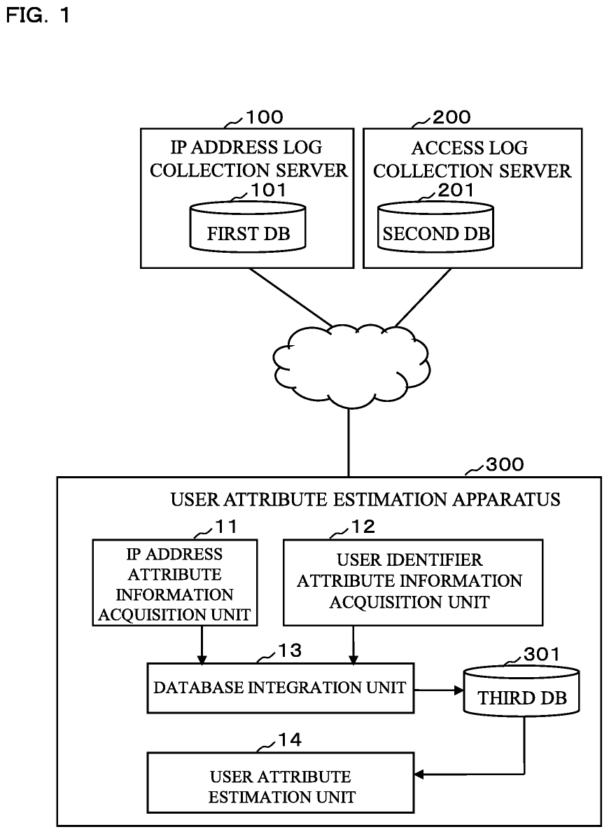

Hereinafter, an embodiment of the invention will be described with reference to the drawings. FIG. 1 is a diagram illustrating the overall configuration of a user attribute estimation system based on an IP address according to the present embodiment together with a functional block of a user attribute estimation apparatus.

As illustrated in FIG. 1, the user attribute estimation system of the present embodiment is configured to include an IP address log collection server 100, an access log collection server 200, and a user attribute estimation apparatus 300. The user attribute estimation apparatus 300 and the IP address log collection server 100 are connected to each other and the user attribute estimation apparatus 300 and the access log collection server 200 are connected to each other through the Internet or a communication network, such as a mobile phone network, so that data communication therebetween can be performed.

The IP address log collection server 100 acquires an IP address used when a user terminal (not illustrated) performs communication through a communication network, generates attribute information unique to the IP address by analyzing the IP address in various ways, and stores the generated attribute information in a first database 101.

On the communication network, many users located in various places access desired websites from each user terminal at a desired timing to browse contents, or perform communication with other user terminals, servers, and the like or various communications, such as data acquisition. The IP address log collection server 100 acquires an IP address used for these communications each time, generates attribute information unique to the IP address by analyzing the IP address in various ways, and stores the generated attribute information in the first database 101 in a sequential manner.

As a result, in the first database 101, IP address attribute information in which an IP address is associated with attribute information specifiable based on the IP address is stored as history information together with the IP address acquisition date and time information. Details of the history information will be described later.

Incidentally, acquisition of the IP address and generation of the attribute information by analysis of the IP address by the IP address log collection server 100 can be performed by applying a known technique. For example, according to the methods disclosed in Patent Documents 1 to 3, acquisition of an IP address and analysis of attribute information that can be specified based on the IP address can be performed. Details will be omitted, but the content thereof will be briefly described below.

The IP address is numerical data having a predetermined number of bits, is configured to include a network address part indicating a corresponding network and a host address part indicating a corresponding computer, and indicates an address on a network of each server present all over the world. The IP address corresponds to a character string including certain meaning, for example, a domain name, such as “˜.provider name.ne.jp” or “˜.company name.co.jp”, in a one-to-one manner, and these can be converted to each other. That is, the IP address always corresponds to a specific server having an original domain in a one-to-one manner.

In addition, from information obtained by a network information center (NIC) that is an organization managing the domains of the whole world, JPNIC managing the domains of Japan, and the like, it is clarified where in which region of which country a specific server having an original domain has an address. The IP address log collection server 100 includes in advance a regional address classification database (not illustrated) in which a plurality of IP addresses are classified according to regions based on the information obtained by the NIC, JPNIC, and the like. In the regional address classification database, region information can be stored so as to be classified according to hierarchies, such as country, region, prefecture, and municipality.

On the other hand, an Internet service provider (ISP) used by the majority of individual users manages a large number of IP addresses for each access point provided in many regions so that many users from all over the country can use the IP addresses. Therefore, IP addresses used by the majority of individual users who use the ISP through dial-up IP connection differ for each access. However, it is possible to specify where in which region of which country each access point owned by the ISP is present.

Therefore, the IP address log collection server 100 includes in advance a regional ISP address classification database (not illustrated) in which IP addresses of access points owned by the ISP are classified according to regions. As described above, since the IP address and the domain name correspond to each other in a one-to-one manner, the regional ISP address classification database may include information regarding whether or not each IP address is used by a mobile phone.

For example, the IP address of a user terminal that is a data transmission source is described in the IP header added to data transmitted from the user terminal, and relayed to the IP address log collection server 100. The IP address log collection server 100 acquires the IP address transmitted from the user terminal, and specifies the server of the original domain from the IP address. Then, by referring to the above-described regional address classification database with the IP address as a key, the IP address log collection server 100 can acquire region information, which indicates a region of the user terminal using the IP address, as attribute information that can be specified based on the IP address.

In addition, the IP address log collection server 100 acquires the IP address transmitted from the user terminal, and determines through which access point of the ISP the communication has been made based on the IP address. Then, by referring to the above-described regional ISP address classification database with the IP address as a key, the IP address log collection server 100 can acquire region information as attribute information corresponding to the IP address. In addition, in a case where almost the accurate installation location of the access point is registered in the regional ISP address classification database, connection location information indicating the connection location of the user terminal, in which the IP address is used, connected to the communication network can be acquired as attribute information corresponding to the IP address.

In addition, as disclosed in Patent Document 3, the IP address log collection server 100 acquires a domain name corresponding to the IP address acquired from the user terminal, extracts a network name from the character string forming the domain name and determines a provider name, and extracts a host name from the character string forming the domain name. Then, by referring to the regional host name classification database in which host names are classified according to regions for each provider, it is also possible to acquire region information from the extracted host name.

In addition, the domain name corresponding to the IP address has a hierarchical structure of host name, organization or company name, organization attribute, and country name. For example, when the domain name is “www.xxx.co.jp”, www is a host name, xxx is a company name, co is an organization attribute, and jp is a country name. The domain name of the access point of the provider can also be determined similarly. Therefore, based on the domain name converted from the IP address acquired from the user terminal, the IP address log collection server 100 can also acquire organization information (company name or the like), which indicates an organization that owns the user terminal using the IP address, as attribute information that can be specified based on the IP address.

The IP address log collection server 100 stores the region information, the connection location information, and the organization information acquired as described above in the first database 101, as the attribute information of the IP address, so as to be associated with the IP address and the IP address acquisition date and time information. By repeating the same process each time an IP address is acquired, the IP address log collection server 100 stores history information, which includes the IP address, date and time information, region information, connection location information, and organization information in one record, in the first database 101 in a sequential manner.

Incidentally, in a case where the IP address log collection server 100 acquires a first IP address, which is not registered in advance in the regional address classification database, the regional ISP address classification database, and the like, from the user terminal, it is not possible to acquire region information, connection location information, and organization information corresponding to the IP address. In addition, in a case where there is no registration of any of the region information, the connection location information, and the organization information even though the IP address is registered in the regional address classification database, the regional ISP address classification database, or the like, it is not possible to acquire the information that is not registered. In this case, the region information, the connection location information, and the organization information are not recorded in the record of the first database 101 corresponding to the IP address.

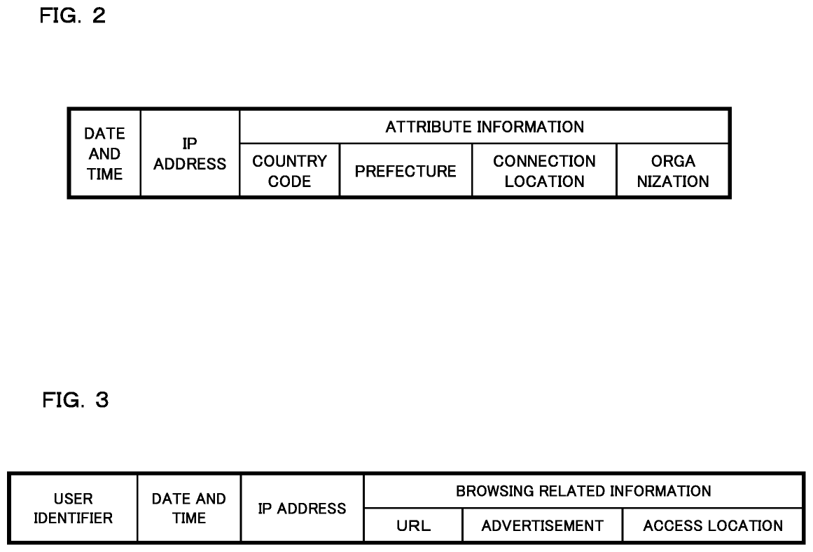

FIG. 2 is a diagram showing an example of the record of history information stored in the first database 101. As shown in FIG. 2, in the first database 101, for each access, country code and prefecture (region information is configured to include the country code and the prefecture), connection location information, and organization information are stored as history information so as to be associated with the IP address and the IP address acquisition date and time information acquired by the IP address log collection server 100. For information that cannot be acquired among the prefecture, the connection location information, and the organization information, a value of “unknown” or a Null value is recorded. In this manner, in the first database 101, IP address attribute information in which an IP address is associated with attribute information specifiable based on the IP address is stored as history information together with the date and time information.

When a user terminal (not illustrated) accesses a website through a communication network, the access log collection server 200 acquires a user identifier and an IP address being used and browsing related information of the website, and stores these in a second database 201.

As described above, on the communication network, many users located in various places access desired websites from each user terminal at a desired timing to browse contents. In addition, when accessing a specific website, it may be necessary to enter a user identifier and a password. Every time this access is made, the access log collection server 200 acquires the user identifier and the IP address used for the access and the browsing related information and sequentially stores these in the second database 201.

As a result, in the second database 201, the user identifier, the IP address, and the website browsing related information are stored as history information together with the acquisition date and time information of such information. Details of the history information will be described later.

Incidentally, acquisition of the user identifier, the IP address, and the browsing related information by the access log collection server 200 can be performed by applying a known technique. Details will be omitted, but the content thereof will be briefly described below.

For example, an analysis tag by JavaScript (registered trademark) is embedded in advance in a website for which access history information is to be acquired. The analysis tag is a known simple program capable of collecting access logs to websites. When access is made to the website in which the analysis tag is embedded, the program is executed, and various kinds of browsing related information is acquired and transmitted to the access log collection server 200.

The browsing related information acquired by the analysis tag through the access to the website is, for example, location information (uniform resource locator (URL)) of the website accessed (browsed) by the user. In addition, in a case where an advertisement placed in the website is browsed (clicked), the analysis tag can also acquire advertisement specifying information for specifying the advertisement. The advertisement specifying information may be, for example, an advertisement ID assigned in advance to the advertisement to be displayed.

In addition, by using the analysis tag, device information (for example, a MAC address or a serial number) of the user terminal used for accessing the website can be acquired as the browsing related information of the user acquired through the access to the website. In addition, in a case where the user terminal has a built-in location detection apparatus, such as a GPS, it is also possible to acquire access location information indicating the location of the user terminal accessing the website.

The access log collection server 200 stores various kinds of browsing related information, which have been acquired using the analysis tag of each website as described above, in the second database 201 so as to be associated with the user identifier, the IP address, and the IP address acquisition date and time information. By repeating the same process each time the above-described information is acquired from the analysis tag of each website, the access log collection server 200 stores history information, which includes the user identifier, the IP address, date and time information, and various kinds of browsing related information in one record, in the second database 201 in a sequential manner.

Incidentally, in a case where the user has not clicked the advertisement placed in the website, no advertisement specifying information is recorded in the record of the second database 201 corresponding to the user identifier. In addition, in a case where a location detection apparatus, such as a GPS, is not mounted in the user terminal that the user uses for access, no access location information is recorded in the record of the second database 201 corresponding to the user identifier.

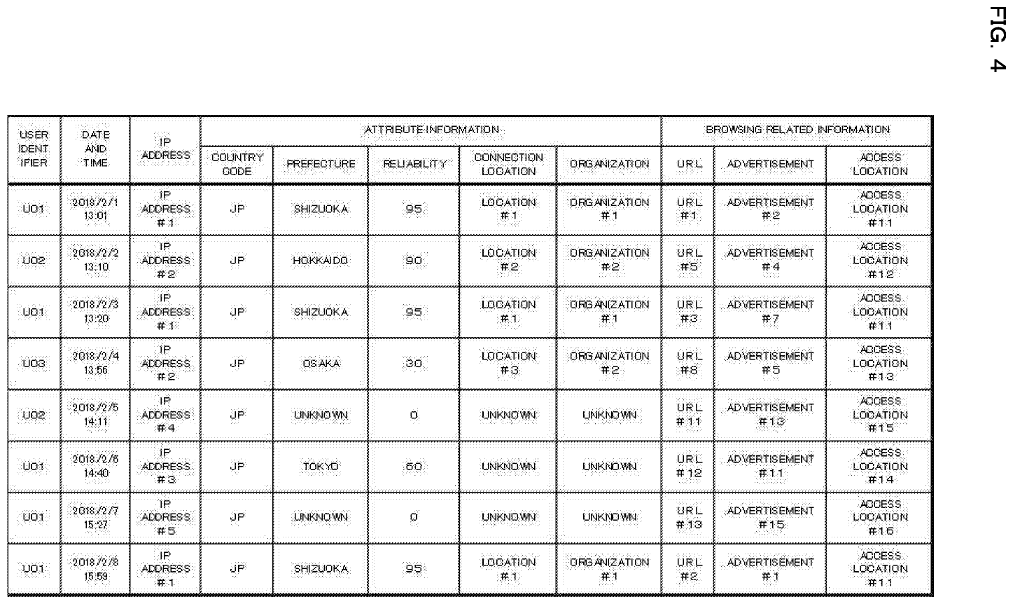

FIG. 3 is a diagram showing an example of the record of history information stored in the second database 201. As shown in FIG. 3, in the second database 201, for each access, browsing related information including an IP address, a URL of a website being browsed, advertisement specifying information, access location information, and the like is stored as history information so as to be associated with the user identifier and the user identifier acquisition date and time information acquired by the access log collection server 200. In this manner, in the second database 201, user identifier attribute information in which a user identifier acquired when the user terminal accesses a website is associated with an IP address and browsing related information acquired through the access to the website is stored as history information together with the date and time information.

Next, the functional configuration of the user attribute estimation apparatus 300 will be described. As illustrated in FIG. 1, the user attribute estimation apparatus 300 includes an IP address attribute information acquisition unit 11, a user identifier attribute information acquisition unit 12, a database integration unit 13, and a user attribute estimation unit 14 as its functional configuration. In addition, the user attribute estimation apparatus 300 includes a third database 301 as a storage medium.

Each of the functional blocks 11 to 14 can be configured by any of hardware, a digital signal processor (DSP), and software. For example, in a case where each of the functional blocks 11 to 14 is configured by software, in practice, each of the functional blocks 11 to 14 is configured to include a CPU, a RAM, a ROM, and the like of a computer and is realized by operating a program stored in a recording medium, such as a RAM, a ROM, a hard disk, or a semiconductor memory.

The IP address attribute information acquisition unit acquires IP address attribute information, which is configured to include the IP address and the attribute information corresponding to the IP address, from the first database 101 together with the date and time information of the history.

Here, the IP address attribute information acquisition unit 11 acquires the IP address attribute information of a plurality of records from the first database 101. In this case, the plurality of records may be all records of the first database 101, or may be some records of the first database 101. The rule in the case of acquiring the IP address attribute information of some records can be arbitrarily set. For example, it is conceivable to acquire the IP address attribute information of the latest predetermined period or a predetermined number of records.

The user identifier attribute information acquisition unit 12 acquires user identifier attribute information, which is configured to include the user identifier and the IP address and the browsing related information corresponding to the user identifier, from the second database 201 together with the date and time information of the history.

Here, the user identifier attribute information acquisition unit 12 acquires the user identifier attribute information of a plurality of records from the second database 201. In this case, the plurality of records may be all records of the second database 201, or may be some records of the second database 201. The rule in the case of acquiring the IP address attribute information of some records can be arbitrarily set. For example, it is conceivable to acquire the user identifier attribute information of the latest predetermined period or a predetermined number of records.

The database integration unit 13 integrates the history information of the IP address attribute information acquired by the IP address attribute information acquisition unit 11 and the history information of the user identifier attribute information acquired by the user identifier attribute information acquisition unit 12 into the third database 301 by using the IP address and the date and time information of the history as a key.

That is, the database integration unit 13 integrates information of a certain record in the IP address attribute information stored in the first database 101 as shown in FIG. 2 and information of a certain record in the user identifier attribute information stored in the second database 201 as shown in FIG. 3 into one record of the third database 301. Here, the two records of the databases 101 and 102 to be integrated are records having the same IP address and date and time information.

On the other hand, records having at least either different IP addresses or different date and time information are not integrated. In this case, only the IP address attribute information of one record acquired from the first database 101 or the user identifier attribute information of one record acquired from the second database 201 is recorded in one record of the third database 301.

FIG. 4 is a diagram showing an example of integrated information stored in the third database 301. In FIG. 4, integrated information of eight records is shown. Here, FIG. 4 shows a state in which IP address attribute information acquired from the first database 101 and user identifier attribute information acquired from the second database 201 are integrated and recorded in all eight records.

As shown in FIG. 4, a user identifier, date and time information, an IP address, IP address attribute information (country code, prefecture, reliability, connection location information, and organization information), and browsing related information (URL of browsing website, advertisement specifying information, and access location information) are recorded in each record of the third database 301. Among these, the date and time information and the IP address are common information acquired from both the first database 101 and the second database 201. The IP address attribute information is information acquired from the first database 101. The user identifier and the browsing related information are information acquired from the second database 201.

Here, the reliability is an index value indicating how reliable the regional information, which is estimated from the IP address with reference to the regional address classification database, the regional ISP address classification database, or the like by the IP address log collection server 100, is (reliability of estimation of a region where the user terminal using the IP address is present), and is calculated based on a predetermined logic by the database integration unit 13.

For example, the database integration unit 13 calculates the reliability according to the logic whose value changes according to the size of a region that can be estimated from the same IP address. Here, the logic in which the reliability changes according to the size of a region that can be estimated is a logic in which the reliability increases to the extent that a relatively narrow region can be specified and estimated from the IP address and decreases to the extent that the estimation range can be limited only to a relatively wide region.

As an example, the reliability is calculated according to the logic in which the reliability is the highest in a case where a region can be specified and estimated up to the size of a single prefecture, second highest in a case where a region can be estimated up to the size of eight regional divisions, third highest in a case where a region can be estimated up to only the size of two sections of East Japan/West Japan, and lowest in a case where any of the two sections cannot be specified (in a case where only somewhere in Japan is known).

Incidentally, except for a case where the region can be estimated up to the size of a single prefecture, a predetermined main prefecture among a plurality of prefectures included in the estimated range is specified, and the reliability corresponding to the size of the estimated range is calculated. For example, in the example of the third database 301 shown in FIG. 4, “Shizuoka”, “Hokkaido”, “Osaka”, and “Tokyo” are estimated as prefectures, and their reliabilities are “95”, “90”, “30”, and “60”, respectively. Among these, “Shizuoka” with a reliability of “95” indicates a case where a region can be specified and estimated up to a single prefecture. “Tokyo” with a reliability of “60” indicates a case where somewhere in the Kanto region is estimated and the most important “Tokyo” in the Kanto region is specified and “60” is calculated as the reliability.

The user attribute estimation unit 14 estimates the attribute of the user based on the information stored in the third database 301 obtained by the integration of the database integration unit 13. Depending on which information of the third database 301 is used, it is possible to estimate various attributes of the user.

For example, the user attribute estimation unit 14 estimates the user's residence region (base region as the center of daily life) corresponding to the user identifier based on the region information (prefecture) acquired from the first database 101 and the user identifier acquired from the second database 201 among the pieces of information stored in the third database 301 obtained by the integration of the database integration unit 13.

For example, in the third database 301 shown in FIG. 4, five records relevant to the user identifier “U01” are included. In addition, the IP addresses stored in the five records are “#1”, “#1”, “#3”, “#5”, and “#1”, respectively, and the region information (prefectures) is “Shizuoka”, “Shizuoka”, “Tokyo”, “Unknown”, and “Shizuoka”. In addition, the estimated reliabilities of these regions are “95”, “95”, “60”, “0”, and “95”, respectively.

It can be said that this indicates that the user of the user identifier “U01” occasionally accesses from different regions but most of the users access from “Shizuoka” using the IP address “#1”. Therefore, in this case, the user attribute estimation unit 14 estimates that the user's residence region corresponding to the user identifier “U01” is “Shizuoka”.

In addition, the user attribute estimation unit 14 estimates an organization (company name) to which the user belongs corresponding to the user identifier based on the organization information acquired from the first database 101 and the user identifier acquired from the second database 201 among the pieces of information stored in the third database 301 obtained by the integration of the database integration unit 13.

For example, in the third database 301 shown in FIG. 4, five records relevant to the user identifier “U01” are included. In addition, the IP addresses stored in the five records are “#1”, “#1”, “#3”, “#5”, and “#1”, respectively, and the organization information is “organization #1”, “organization #1”, “unknown”, “unknown”, and “organization #1”. Therefore, in this case, the user attribute estimation unit 14 estimates that the organization to which the user belongs corresponding to the user identifier “U01” is “organization #1”.

In addition, the user attribute estimation unit 14 can also estimate an organization and an occupation to which the user belongs corresponding to the user identifier based on the organization information acquired from the first database 101 and the user identifier and the URL of the browsing website acquired from the second database 201 among the pieces of information stored in the third database 301 obtained by the integration of the database integration unit 301.

For example, first, the user attribute estimation unit 14 estimates an organization to which the user belongs using the method described above. In addition, the user attribute estimation unit 14 specifies content of the contents (content information of the website) displayed on the website specified by the URL based on the URL of the browsing website, and estimates the occupation of the user based on the content of the contents and the estimated organization to which the user belongs.

In order to make such estimation possible, for example, the user attribute estimation unit 14 includes first table information in which a URL and content information (for example, a predetermined category or the like) of the contents displayed on the website are stored so as to be associated with each other, second table information in which organization information regarding an organization (for example, a company name and an existing department name) is stored for each organization, and a matrix table that enables specifying the occupation with the category of contents and the department as two axes.

That is, the user attribute estimation unit 14 specifies the category of the display contents corresponding to the URL by referring to the first table information using the URL included in the third database 301. In addition, the user attribute estimation unit 14 specifies a department name existing in the organization corresponding to the company name by referring to the second table information using the organization information (company name) included in the third database 301. Then, the user attribute estimation unit 14 specifies the occupation of the user by referring to the matrix table using the category of the contents and the department name specified as described above.

Here, in a case where there are a plurality of department names specified from the second table information, there is a possibility that there will be a plurality of occupations specified from the matrix table using the plurality of department names. In such a case, the number of occupations to be specified may be plural. Alternatively, in order to be able to specify one occupation even in a case where there are a plurality of department names specified from the second table information, for example, priorities may be set for a plurality of combinations of the category of display contents and departments, and one occupation may be specified from the combination with the highest priority.

In addition, the occupation estimation method described herein is merely an example, and the occupation of the user may also be estimated from the URL of the browsing website and the organization information using other methods. For example, the occupation of the user can also be estimated by performing machine learning with the URL of the browsing website, the category of contents, and the organization information (company name, department name, and the like) as explanatory variables and the occupation as an objective variable.

In addition, although the example of estimating the occupation of the user from the URL of the browsing website and the organization information is shown herein, advertisement specifying information may be further used. That is, the category of contents displayed on the website specified by the URL may be specified and the category of advertisement contents specified by the advertisement specifying information may be specified, and the occupation of the user may be estimated based on the content of the respective contents and the estimated organization to which the user belongs.

In addition, the user attribute estimation unit 14 can also estimate an organization and a department to which the user belongs corresponding to the user identifier based on the organization information acquired from the first database 101 and the user identifier and the URL of the browsing website acquired from the second database 201 among the pieces of information stored in the third database 301.

For example, first, the user attribute estimation unit 14 estimates an occupation that the viewer is likely to be interested in the display contents based on content of the display contents corresponding to the URL included in the third database 301. Then, the user attribute estimation unit 14 estimates an organization to which the user belongs using the above-described method, and estimates to which department, among departments existing in the organization, the user belongs based on the estimated organization and the occupation estimated as described above.

In order to make such estimation possible, for example, the user attribute estimation unit 14 includes first table information in which a URL and an occupation (occupation relevant to the displayed contents) assumed from content of the contents displayed on the website are stored so as to be associated with each other and the second table information in which organization information regarding an organization (for example, a company name, an existing department name, and an occupation relevant to each department) is stored for each organization.

Then, the user attribute estimation unit 14 specifies an occupation corresponding to the URL as an occupation that the viewer is likely to be interested in the displayed contents by referring to the first table information using the URL included in the third database 301. In addition, the user attribute estimation unit 14 specifies a department name corresponding to the occupation, among departments existing in the organization corresponding to the company name, by referring to the second table information using the organization information (company name) included in the third database 301 and the occupation specified as described above.

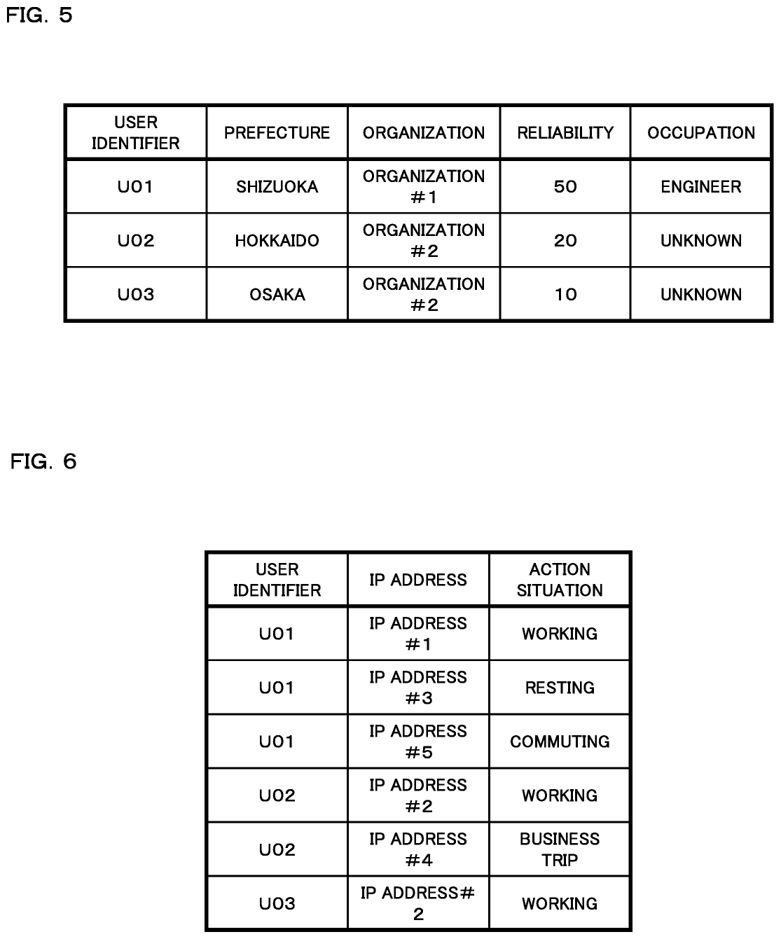

FIG. 5 is a diagram showing an example of user attributes estimated by the user attribute estimation unit 14 as described above. Here, an example of the result of estimating the user attribute for three users of user identifiers “U01”, “U02”, and “U03” recorded in the third database 301 shown in FIG. 4 is shown.

The reliability shown herein indicates the reliability of the residence region estimated by the user attribute estimation unit 14, and is calculated by the user attribute estimation unit 14 using the value of the reliability stored in the first database 101 shown in FIG. 2. For example, “Shizuoka” is estimated as the residence region of the user whose user identifier is “U01”, and the value of “50” is calculated as the reliability. The value of the reliability is obtained as a result of performing a predetermined calculation using five reliabilities “95”, “95”, “60”, “0”, and “95” stored in the first database 101 for the user whose user identifier is “U01”.

In addition, the user attribute estimation unit 14 can also estimate the action situation of the user corresponding to the user identifier based on the connection location information acquired from the first database 101 and the user identifier acquired from the second database 201 among the pieces of information stored in the third database 301 obtained by the integration of the database integration unit 13. The action situation referred to herein is to which one of action modes, such as working, commuting, business trip, and resting, the user's action corresponds.

For example, the user attribute estimation unit 14 includes a map database, and specifies to which location on the map the connection location information of the access point corresponds. Then, working is estimated when the specified location is an office building, commuting or business trip is estimated when the specified location is a road, a railroad, or the like, and resting is estimated when the specified location is a place where it is possible to take a break, such as a coffee shop or a park. In addition, by further considering the user's residence region estimated as described above, commuting may be determined when the specified location is within the user's residence region, and business trip or the like may be determined otherwise.

In addition, the user attribute estimation unit 14 can also estimate the user's action situation based on the reliability information of the region estimation in addition to the user identifier and the connection location information stored in the third database 301. For example, as described above, in a case where the regional ISP address classification database provided in the IP address log collection server 100 includes information regarding whether or not each IP address is used by the mobile phone, it is possible to calculate the reliability using the information. That is, it is possible to calculate the reliability using the logic that reduces the reliability in a case where a mobile line is used instead of a fixed line. Therefore, in a case where the reliability information indicates a value smaller than a predetermined value, the user attribute estimation unit 14 can estimate that the user is commuting or on a business trip.

FIG. 6 is a diagram showing an example of the user's action situation estimated by the user attribute estimation unit 14 as described above. Here, an example of the result of estimating the action situation for three users of user identifiers “U01”, “U02”, and “U03” recorded in the third database 301 shown in FIG. 4 is shown. Here, an IP address is also shown corresponding to the user identifier. This can be said to be the result of estimating what kind of action the user tends to take when a certain IP address is used.

As described in detail above, the user attribute estimation apparatus 300 of the present embodiment acquires the IP address attribute information, in which an IP address is associated with attribute information specifiable based on the IP address, from the first database 101 together with the date and time information of the history. On the other hand, the user identifier attribute information in which a user identifier acquired when the user terminal accesses a website is associated with an IP address and the browsing related information acquired through the access to the website is acquired from the second database 201 together with the date and time information of the history. Then, the history information of the IP address attribute information acquired from the first database 101 and the history information of the user identifier attribute information acquired from the second database 201 are integrated into the third database 301 by using the IP address and the date and time information of the history as a key, and then the attribute of the user is estimated based on the information stored in the third database 301.

According to the present embodiment configured as described above, although only the attribute information unique to the IP address can be obtained from the IP address in a case where only the first database 101 is used, the attribute information unique to the IP address and the browsing related information of the website by the user are stored so as to be associated with the IP address and the user identifier since the user identifier and the browsing related information of the website are acquired from the second database 201 together with the IP address and the information acquired from the respective databases 101 and 201 is integrated into the third database 301 by using the IP address and the date and time information of the history as a key. Then, based on the integrated information, the attribute of the user specified by the user identifier is estimated. Therefore, it is possible to estimate the attribute of the user that cannot be estimated with only the information of the first database 101 or only the information of the second database 201. As a result, it is possible to increase the number of pieces of user attribute information that can be acquired corresponding to the IP address acquired at the time of access to the network.

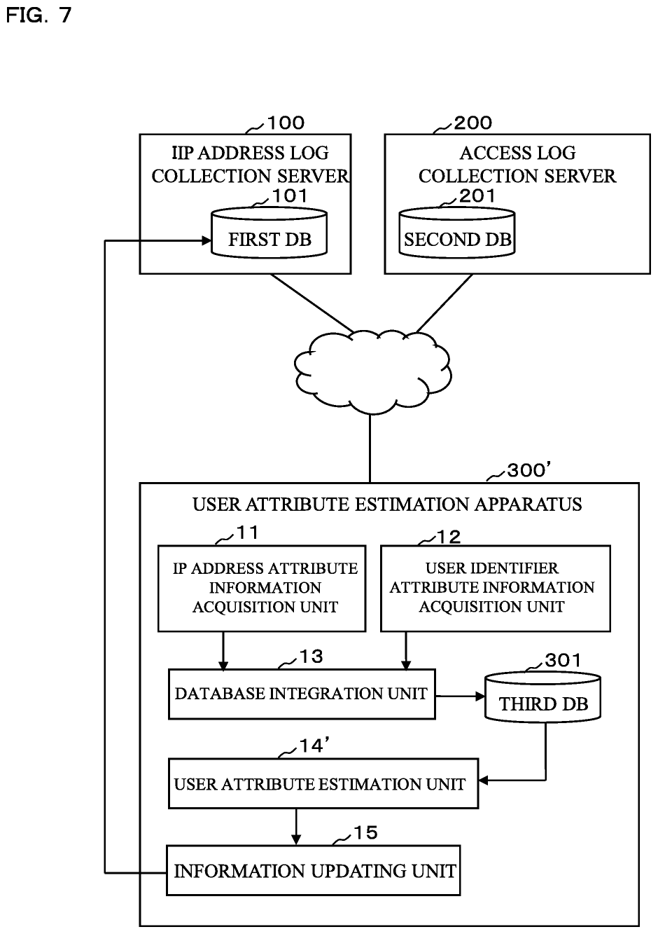

FIG. 7 is a diagram illustrating an example of the functional configuration of a user attribute estimation apparatus 300′ according to another embodiment. In addition, in FIG. 7, since components denoted by the same reference numerals as those illustrated in FIG. 1 have the same functions, repeated description thereof will be omitted herein.

The user attribute estimation apparatus 300′ having the configuration illustrated in FIG. 7 further includes an information updating unit 15 as its functional configuration, and includes a user attribute estimation unit 14′ instead of the user attribute estimation unit 14. The user attribute estimation unit 14′ has the following estimation function in addition to the above-described estimation function of the user attribute estimation unit 14.

That is, the user attribute estimation unit 14′ estimates the user's residence region corresponding to the user identifier based on the region information acquired from the first database 101 and the user identifier acquired from the second database 201 among the pieces of information stored in the third database 301 obtained by the integration of the database integration unit 13. This is the same as the function of the user attribute estimation unit 14.

In addition to this, the user attribute estimation unit 14′ estimates the user's residence region corresponding to the user identifier based on the access location information and the user identifier acquired from the second database 201. Here, the user attribute estimation unit 14′ has a map database, and estimates the user's residence region by specifying to which region on the map the access location information corresponds.

Ina case where the value of the reliability (reliability shown in FIG. 5) of the region estimation calculated by the user attribute estimation unit 14′ satisfies predetermined conditions, the information updating unit 15 updates the region information stored in the first database 101 of the IP address log collection server 100 according to the user's residence region estimated using the access location information acquired from the second database 201. Region information corresponding to the IP address associated with the user identifier of the record in which the reliability determined to satisfy the predetermined condition is stored is updated. The predetermined conditions can be, for example, conditions in which the value of the reliability is smaller than a predetermined value.

For example, in the example shown in FIG. 5, the value of the reliability of the region estimation calculated by the user attribute estimation unit 14′ for the user of the user identifier “U03” is “10”, and this is assumed to be smaller than the predetermined value. In this case, the information updating unit 15 specifies the IP address, which is associated with the user identifier “U03” of the record in which the reliability “10” smaller than the predetermined value is stored, by referring to the third database 301 shown in FIG. 4. In this case, “IP address #2” is specified. Then, the information updating unit 15 updates region information “Osaka”, which is stored in the first database 101 so as to be associated with “IP address #2”, according to the user's residence region estimated using the access location information acquired from the second database 201.

As described above, since the access location information acquired from the second database 201 is location information detected by the GPS or the like provided in the user terminal used for accessing the website, it can be said that the access location information acquired from the second database 201 almost accurately indicates the location of the user. Therefore, in a case where the reliability of the user's residence region estimated based on the region information acquired from the first database 101 is smaller than the predetermined value, by updating the region information stored in the first database 101 of the IP address log collection server 100 according to the residence region estimated based on the accurate access location information, it is possible to improve the accuracy of the information stored in the first database 101.

In addition, in a case where the reliability of the user's residence region estimated based on the region information acquired from the first database 101 is zero or a value close to zero, there is a possibility that the region corresponding to the IP address is unknown and the region information is not recorded in the first database 101. On the other hand, by executing the processing of the information updating unit 15, it is possible to record the region information in a record in which the region information is not stored in the first database 101 of the IP address log collection server 100. As a result, it is possible to improve the degree of completion of the first database 101.

In addition, all of the above-described embodiments are merely examples showing specific examples for carrying out the invention, and the technical scope of the invention should not be interpreted restrictively due to these. That is, the invention can be carried out in various forms without deviating from the gist thereof or its main features.

For example, in a case where the user's profile information (birthday, sex, and the like) is acquired in addition to the user identifier when the user terminal accesses the website, the user attribute may be estimated by further using the profile information.

In addition, in a case where information (organization name, statistical information, and the like) from the data provider is acquired as the browsing related information of the user acquired when the user terminal accesses the website, the user attribute may be estimated by further using the information from the provider.

### REFERENCE SIGNS LIST

11 IP address attribute information acquisition unit
12 User identifier attribute information acquisition unit
13 Database integration unit
14, 14′ User attribute estimation unit
15 Information updating unit
100 IP address log collection server
101 First database
200 Access log collection server
201 Second database
300 User attribute estimation apparatus
301 Third database

1. A user attribute estimation system based on an IP address, comprising:
an IP address attribute information acquisition unit that acquires IP address attribute information, in which an IP address is associated with attribute information specifiable based on the IP address, from a first database in which the IP address attribute information is stored as history information together with date and time information;
a user identifier attribute information acquisition unit that acquires user identifier attribute information, in which a user identifier acquired when a user terminal accesses a website is associated with an IP address and browsing related information acquired through access to the website, from a second database in which the user identifier attribute information is stored as history information together with date and time information;
a database integration unit that integrates history information of the IP address attribute information acquired by the IP address attribute information acquisition unit and history information of the user identifier attribute information acquired by the user identifier attribute information acquisition unit into a third database by using the IP address and the date and time information as a key; and
a user attribute estimation unit that estimates an attribute of the user based on information stored in the third database obtained by the integration of the database integration unit.

2. The user attribute estimation system based on an IP address according to claim 1,
wherein the IP address attribute information acquisition unit acquires region information indicating a region of the user terminal using the IP address, as attribute information specifiable based on the IP address, from the first database, and
the user attribute estimation unit estimates a residence region of the user corresponding to the user identifier based on the region information acquired from the first database and the user identifier acquired from the second database among the pieces of information stored in the third database obtained by the integration of the database integration unit.

3. The user attribute estimation system based on an IP address according to claim 1,
wherein the IP address attribute information acquisition unit acquires organization information indicating an organization that owns the user terminal using the IP address, as attribute information specifiable based on the IP address, from the first database, and
the user attribute estimation unit estimates an organization to which the user belongs corresponding to the user identifier based on the organization information acquired from the first database and the user identifier acquired from the second database among the pieces of information stored in the third database obtained by the integration of the database integration unit.

4. The user attribute estimation system based on an IP address according to claim 3,
wherein the user identifier attribute information acquisition unit acquires location information of the accessed website as the browsing related information of the user acquired through access to the website, and
the user attribute estimation unit estimates an organization and an occupation to which the user belongs corresponding to the user identifier based on the organization information acquired from the first database and the user identifier and content information of the website specified based on the location information of the website, which are acquired from the second database, among the pieces of information stored in the third database obtained by the integration of the database integration unit.

5. The user attribute estimation system based on an IP address according to claim 3,
wherein the user identifier attribute information acquisition unit acquires location information of the accessed website as the browsing related information of the user acquired through access to the website, and
the user attribute estimation unit estimates an organization and a department to which the user belongs corresponding to the user identifier based on the organization information acquired from the first database and the user identifier and an occupation specified based on the location information of the website, which are acquired from the second database, among the pieces of information stored in the third database obtained by the integration of the database integration unit.

6. The user attribute estimation system based on an IP address according to claim 1,
wherein the IP address attribute information acquisition unit acquires connection location information indicating a connection location of the user terminal, in which the IP address is used, connected to a communication network, as attribute information specifiable based on the IP address, from the first database, and
the user attribute estimation unit estimates an action situation of the user corresponding to the user identifier based on the connection location information acquired from the first database and the user identifier acquired from the second database among the pieces of information stored in the third database obtained by the integration of the database integration unit.

7. The user attribute estimation system based on an IP address according to claim 6,
wherein the IP address attribute information acquisition unit further acquires region information indicating a region of the user terminal using the IP address, as attribute information specifiable based on the IP address, from the first database,
the user attribute estimation unit further estimates a residence region of the user corresponding to the user identifier based on the region information acquired from the first database and the user identifier acquired from the second database among the pieces of information stored in the third database obtained by the integration of the database integration unit, and
the user attribute estimation unit estimates the action situation of the user corresponding to the user identifier based on the region information acquired from the first database, reliability information indicating reliability of estimation of the residence region, and the user identifier acquired from the second database among the pieces of information stored in the third database obtained by the integration of the database integration unit.

8. The user attribute estimation system based on an IP address according to claim 2,
wherein the user identifier attribute information acquisition unit acquires access location information detected by a location detection apparatus provided in the user terminal using the IP address when the user terminal accesses the website, as browsing related information acquired through access to the website, from the second database, and
the user attribute estimation unit estimates the residence region of the user corresponding to the user identifier based on the region information acquired from the first database and the user identifier acquired from the second database among the pieces of information stored in the third database obtained by the integration of the database integration unit, and estimates the residence region of the user corresponding to the user identifier based on the user identifier and the access location information acquired from the second database.

9. The user attribute estimation system based on an IP address according to claim 8,
wherein the user attribute estimation unit calculates a reliability indicating reliability of estimation of the residence region of the user estimated using the region information acquired from the first database, and
an information updating unit that updates the region information stored in the first database according to the residence region of the user estimated using the access location information acquired from the second database in a case where the reliability calculated by the user attribute estimation unit satisfies predetermined conditions is further provided.
